(19) United States
(12) Patent Application Publication
(10) Pub. No.: US 2023/0305296 A1
(43) Pub. Date: Sep. 28, 2023

(54) HEAD-MOUNTED DISPLAY DEVICE AND EYE TRACKING MODULE

(71) Applicant: HTC Corporation, Taoyuan City (TW)

(72) Inventors: Wei-Cheng Hsu, Taoyuan City (TW); Cheng-Yu Chen, Taoyuan City (TW); Syuan-He Shih, Taoyuan City (TW); Chih-Lin Chang, Taoyuan City (TW)

(73) Assignee: HTC Corporation, Taoyuan City (TW)

(21) Appl. No.: 17/875,419

(22) Filed: Jul. 28, 2022

Related U.S. Application Data
(60) Provisional application No. 63/322,230, filed on Mar. 22, 2022.
(60) Provisional application No. 63/328,272, filed on Apr. 7, 2022.

(51) Int. Cl. G02B 27/00; G02B 7/02; G06F 1/16; H04N 5/225; H04N 5/247; G06F 3/01

(52) U.S. Cl. CPC G02B 27/0093; G02B 7/021; G02B 7/022; G06F 1/163; H04N 5/2257; H04N 5/247; G06F 3/011

(57) ABSTRACT

A head-mounted display device includes a body, an eye tracking module and a face gasket. The body has a first lens and a second lens corresponding to both eyes, and also has a first positioning portion. The eye tracking module is assembled to and electrically connected to the body and includes an outer frame, a first camera, a second camera, a first lens frame and a second lens frame. The outer frame has a second positioning portion. The second positioning portion is used for connecting with the first positioning portion, so that the outer frame is positioned on the body. The first lens frame and the second lens frame are movably arranged on the outer frame. The first lens frame is used for connecting the first lens. The second lens frame is used for connecting the second lens. The first camera is arranged on the first lens frame. The second camera is arranged on the second lens frame. The first camera and the second camera are used to shoot both eyes.

### CROSS-REFERENCE TO RELATED APPLICATION

This application claims the priority benefit of U.S. provisional application Ser. No. 63/322,230, filed on Mar. 22, 2022, and U.S. provisional application Ser. No. 63/328,272, filed on Apr. 7, 2022. The entirety of each of the above-mentioned patent applications is hereby incorporated by reference herein and made a part of this specification.

### BACKGROUND

### Technical Field

The disclosure relates to a head-mounted display device and eye tracking module, and in particular, to a head-mounted display device and eye tracking module with eye-tracking function.

### Description of Related Art

With the rapid advancement of current technology, the types and functions of head-mounted display devices are also increasingly diversified. Taking an eye mask type head-mounted display device as an example, when a user wears such a device, a gyroscope and a position tracker inside the head-mounted display device will track the user's movement state to deliver a corresponding scene image. Accordingly, the user is provided with an experience as if they were in a virtual world.

In order to enrich the experience, there are currently extensions that can provide eye tracking functions, allowing users to install on the head-mounted display device to increase the experience related to eye tracking. The existing extensions that provide the function of eye tracking provide two independent cameras, and the two cameras are respectively fixed to the two lenses of the head-mounted display device. However, when the user fixes the camera to the lens, there is often offset and rotation in two axes perpendicular to the line of sight. In addition, there is also an offset in the direction of the line of sight, which causes the eye tracking function to fail to function properly, and the camera may not even capture the image of the eye. Even if one camera and its corresponding lens are assembled correctly, errors may still occur in the assembly of the other camera and its corresponding lens, which may affect the normal performance of the eye tracking function.

### SUMMARY

The application provides a head-mounted display device and an eye-tracking module, which can improve the problem caused by the assembly error of an expansion piece that provides the function of eye-tracking.

The head-mounted display device of the application includes a body, an eye tracking module and a face gasket. The body has a first lens and a second lens corresponding to both eyes, and also has a first positioning portion. The eye tracking module is assembled to and electrically connected to the body and includes an outer frame, a first camera, a second camera, a first lens frame and a second lens frame. The outer frame has a second positioning portion. The second positioning portion is used for connecting with the first positioning portion, so that the outer frame is positioned on the body. The first lens frame and the second lens frame are movably arranged on the outer frame. The first lens frame is used for connecting the first lens. The second lens frame is used for connecting the second lens. The first camera is arranged on the first lens frame. The second camera is arranged on the second lens frame. The first camera and the second camera are used to shoot both eyes. The face gasket is assembled to the eye tracking module. The eye tracking module is located between the face gasket and the body.

The eye tracking module of the application is applied to a head-mounted display device. The eye-tracking module is assembled and electrically connected to a body of the head-mounted display device, and the eye tracking module is located between a face gasket of the head-mounted display device and the body. The eye tracking module comprises an outer frame, a first camera, a second camera, a first lens frame and a second lens frame. The outer frame has a second positioning portion. The second positioning portion is used for connecting with a first positioning portion of the body, so that the outer frame is positioned on the body. The first lens frame and the second lens frame are movably arranged on the outer frame. The first lens frame is used for connecting a first lens of the body. The second lens frame is used for connecting a second lens of the body. The first camera is arranged on the first lens frame. The second camera is arranged on the second lens frame. The first camera and the second camera are used to shoot both eyes.

Based on the above, in the head mounted display device and the eye tracking module of the application, the eye tracking module has an outer frame. Using the positioning of the outer frame and the body, the positioning of the two cameras and the two lenses can be completed at one time, so as to ensure the eye tracking function is working properly.

### BRIEF DESCRIPTION OF THE DRAWINGS

FIG. 1 is a schematic diagram of an assembled state of a head-mounted display device according to an embodiment of the invention.

FIG. 2 is a schematic diagram of a disassembled state of the head-mounted display device of FIG. 1.

FIG. 3 is a schematic cross-sectional view for explaining the assembled state of the eye tracking module and the lens.

FIG. 4 is a schematic diagram of a first lens frame and a second lens frame of the head-mounted display device of FIG. 1.

FIG. 5 is a schematic cross-sectional view of the eye tracking module of the head-mounted display device of FIG. 1.

FIG. 6 is a schematic diagram of a disassembled state of a head-mounted display device according to another embodiment of the invention.

FIG. 7 is a schematic diagram of the relative positions of the head-mounted display device of FIG. 6 and a pair of glasses of a user.

FIG. 8 is a schematic diagram of the relative positions of the head-mounted display device of FIG. 6 and another glasses of a user.

FIG. 9 is a schematic diagram of two distance extenders of the head-mounted display device of FIG. 6.

FIG. 10 is a partial enlarged view of the two distance extenders of the head-mounted display device of FIG. 6 at the engaging pieces.

FIG. 11 is a partial enlarged view of the two distance extenders of the head-mounted display device of FIG. 6 at the magnetic attraction portion.

FIG. 12 is an enlarged partial cross-sectional view of the two distance extenders of the head-mounted display device of FIG. 6 at the nose frame portion.

### DESCRIPTION OF THE EMBODIMENTS

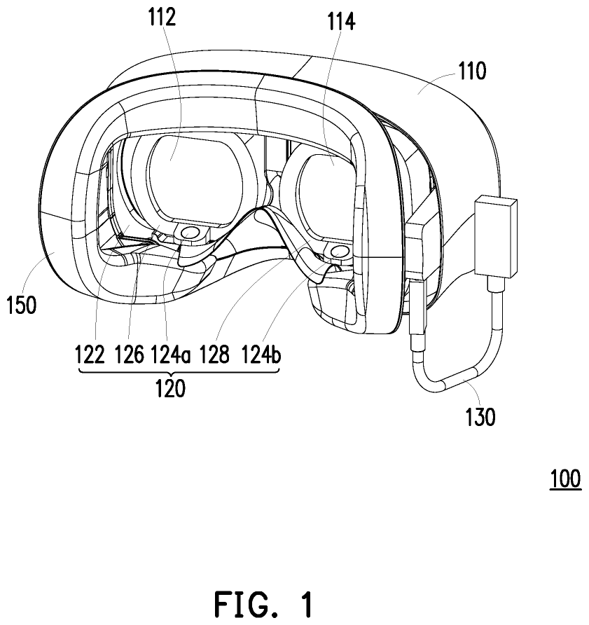

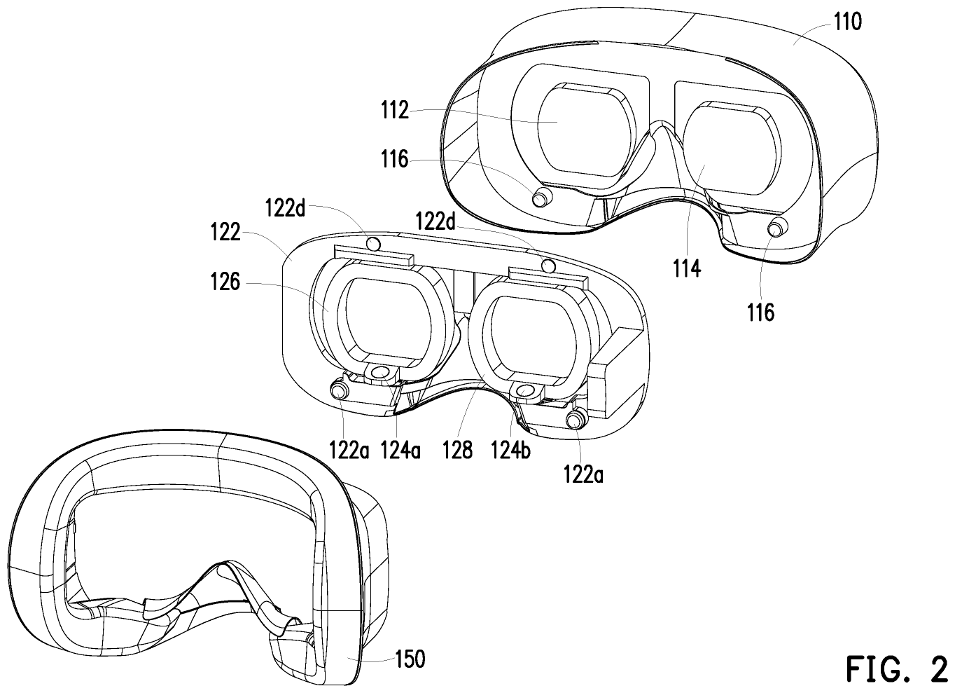

FIG. 1 is a schematic diagram of an assembled state of a head-mounted display device according to an embodiment of the invention. FIG. 2 is a schematic diagram of a disassembled state of the head-mounted display device of FIG. 1. Referring to FIG. 1 and FIG. 2, the head-mounted display device 100 of the embodiment includes a body 110, an eye tracking module 120 and a face gasket 130. The body 110 has a first lens 112 and a second lens 114 corresponding to both eyes, and also has a first positioning portion 116. The eye tracking module 120 is assembled to and electrically connected to the body 110. The eye tracking module 120 includes an outer frame 122, a first camera 124a, a second camera 124b, a first lens frame 126 and a second lens frame 128. The outer frame 122 has a second positioning portion 122a. The second positioning portion 122a is used for connecting with the first positioning portion 116, so that the outer frame 122 is positioned on the body 110. The first lens frame 126 and the second lens frame 128 are movably arranged on the outer frame 122. The first lens frame 126 is used for connecting the first lens 112. The second lens frame 128 is used for connecting the second lens 114. The first camera 124a is arranged on the first lens frame 126. The second camera 124b is arranged on the second lens frame 128. The first camera 124a and the second camera 124b are used to shoot both eyes. The face gasket 150 is assembled to the eye tracking module 120. The eye tracking module 120 is located between the face gasket 150 and the body 110.

In the head-mounted display device 100 of the embodiment, the positions of the first lens 112 and the second lens 114, and the positions of the first lens frame 126 and the second lens frame 128 are adjusted first. Then, the outer frame 122 of the eye tracking module 120 is directly positioned on the body 110. Therefore, the first lens frame 126 is combined with the first lens 112. The second lens frame 128 is combined with the second lens 114. As long as the outer frame 122 is assembled to the body 110, the function of eye tracking can be ensured to perform normally.

In the embodiment, the first positioning portion 116 is, for example, a positioning post. Correspondingly, the second positioning portion 122a has a space for accommodating the first positioning portion 116. The combination of the second positioning portion 122a and the first positioning portion 116 can ensure that there is no offset and rotation in the two axes perpendicular to the line of sight. In addition, by designing the depth of the second positioning portion 122a that can accommodate the first positioning portion 116, it can also be ensured that there is no offset in the line of sight direction. The outer frame 122 may also have a plurality of magnetic attraction portions 122d for magnetically attracting the outer frame 122 to the body 110.

In the embodiment, the number of the first positioning portion 122a and the second positioning portion 122a is multiple. The second positioning portion 122a, for example, magnetically attracts the first positioning portion 116, that is, the second positioning portion 122a is magnetically assembled to the first positioning portion 116. In other words, at least one of the first positioning portion 116 and the second positioning portion 122a has a magnet. Therefore, when the user assembles the outer frame 122 of the eye tracking module 120, the magnetic force can play a guiding role to ensure a small offset in the two axes perpendicular to the line of sight. In addition, by means of magnetic attraction, it can also be avoided that the user does not press the outer frame 122 to the position, so as to ensure a small offset in the direction of sight. Since the outer frame 122 and the body 110 are magnetically attracted to each other, the outer frame 122 generates a continuous and constant downward force on the first lens frame 126 and the second lens frame 128 to maintain the distance between the first lens frame 126 and the first lens 112, and the distance between the second lens frame 128 and the second lens 114. The installation method of the magnetic attraction is relatively easy and clear to the user, and the user can assemble the first lens frame 126 and the second lens frame 128 to the correct position without any special technique. The easy and clear assembly method can reduce the uncertainty factor of the user during installation, thereby reducing the risk of improper assembly of the eye tracking module 120.

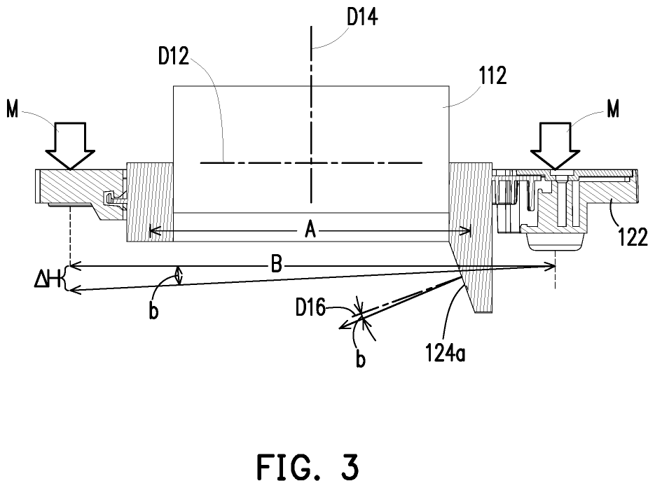

FIG. 3 is a schematic cross-sectional view for explaining the assembled state of the eye tracking module and the lens. Referring to FIG. 2 and FIG. 3, the plurality of second positioning portions 122a in the embodiment are respectively located on opposite sides of the first lens frame 126 and the second lens frame 128. After the plurality of second positioning portions 122a on opposite sides of the first lens frame 126 and the second lens frame 128 are all positioned with the corresponding first positioning portions 116, it can be ensured that the reference direction D12 of the first lens frame 126 assembled on the outer frame 122 can be perpendicular to the optical axis direction D14 of the first lens 112 as expected. Furthermore, it can also ensure that the shooting direction D16 of the first camera 124a on the first lens frame 126 is in the preset ideal direction. Also, since the plurality of second positioning portions 122a are located on opposite sides of the first lens frame 126 and the second lens frame 128, respectively, the effect of suppressing the deflection angle is more pronounced. On the other hand, because the distance B between the two magnetic forces exerted on the outer frame 122 is greater than the width A of the first lens frame 126 itself, even if there is an assembly deviation AH in the optical axis direction D14, the resulting inclination angle b will be smaller than the inclination angle caused by the assembly deviation AH caused only by the first lens frame 126 being directly fixed to the first lens 112.

The two designs of the positioning post and the magnetic attraction can be applied to the first positioning portions 116 and the second positioning portions 122a at the same time, and other suitable positioning designs can also be used, which is not limited in the application. In addition, increasing the number of first positioning portions 116 and second positioning portions 122a can also reduce assembly errors.

In the embodiment, the head-mounted display device 100 further includes a cable 130, which is electrically connected to the body 110 and the eye tracking module 120. The image data captured by the first camera 124a and the second camera 124b on the eye tracking module 120 can be transmitted to the body 110 via the cable 130. However, in other embodiments, the eye tracking module 120 and the body 110 can also be directly electrically connected through a connector without the cable 130.

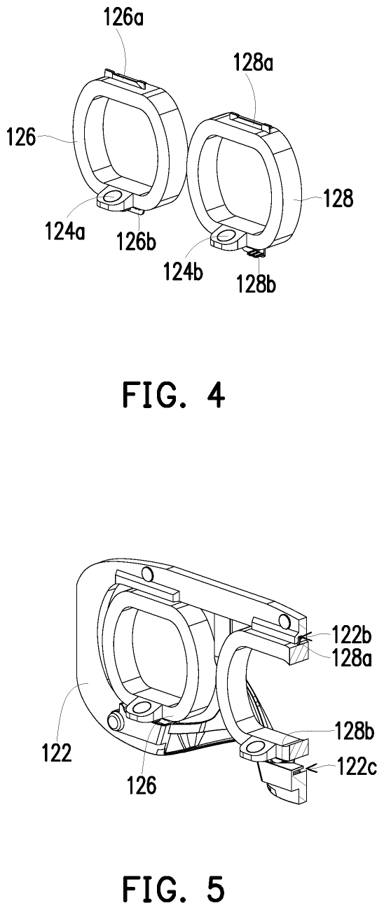

FIG. 4 is a schematic diagram of a first lens frame and a second lens frame of the head-mounted display device of FIG. 1. FIG. 5 is a schematic cross-sectional view of the eye tracking module of the head-mounted display device of FIG. 1. Referring to FIG. 4 and FIG. 5, the first lens frame 126 and the second lens frame 128 in the embodiment are movably disposed on the outer frame 122. When the head-mounted display device 100 is used, since the interpupillary distance of each user is different, the distance between the first lens 112 and the second lens 114 must be adjustable. In this way, each user can get the best experience. Correspondingly, the distance between the first lens frame 126 and the second lens frame 128 in the embodiment is also adjustable, so that both the first lens frame 126 and the second lens frame 128 can accurately combine the first lens 112 and the second lens 114. For example, the first lens frame 126 has hooks 126a and 126b, and the second lens frame 128 has hooks 128a and 128b. The outer frame 122 has a sliding groove 122b and a sliding groove 122c. The second lens frame 128 can move on the outer frame 122 by the cooperation of the hook 128a and the sliding groove 122b and the cooperation of the hook 128b and the sliding groove 122c. In addition, the outer frame 122 also has a sliding groove for matching the hook 126a and the hook 126b, but it is difficult to see in FIG. 5. Therefore, the first lens frame 126 can also be moved on the outer frame 122.

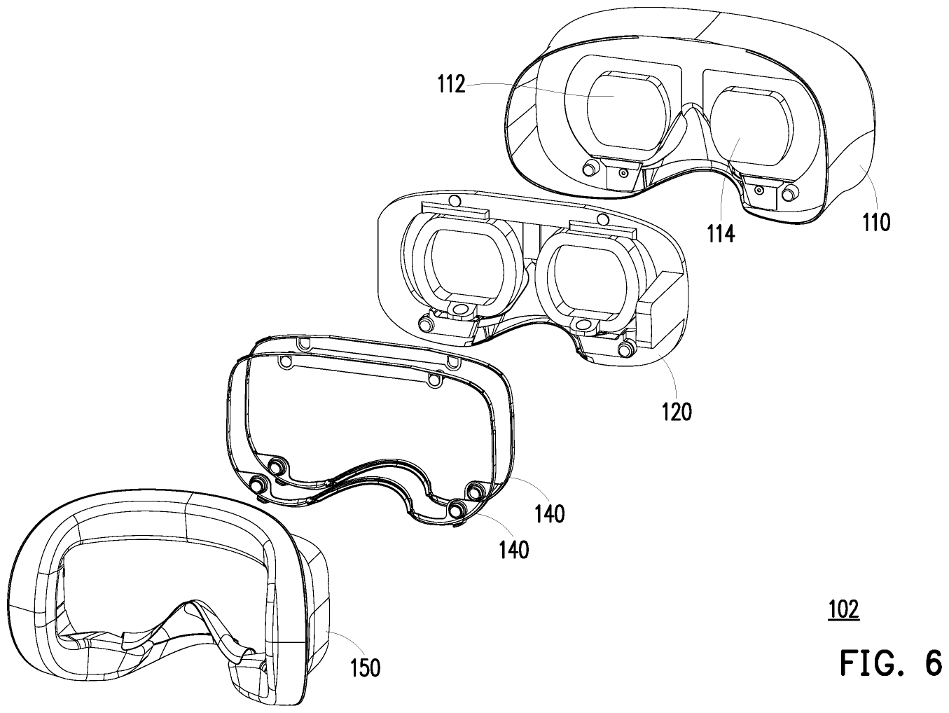

FIG. 6 is a schematic diagram of a disassembled state of a head-mounted display device according to another embodiment of the application. Referring to FIG. 6, the head-mounted display device 102 of the embodiment is similar to the head-mounted display device 100 of FIG. 1. The difference is that the head-mounted display device 102 of the embodiment further includes a distance extender 140 disposed on the side of the eye tracking module 120 facing the user. In FIG. 6, the same cables as the cables 130 shown in FIG. 1 are omitted. Eye-relief (ERF) is a key parameter for the head-mounted display device 102. The smaller the eye relief distance is, the closer the eye is to the first lens 112 and the second lens 114. Therefore, the larger the available angle of view (FOV), the better the user experience. However, many users wear glasses that cause the glasses to be too close to the first lens 112 and the second lens 114 when using the head-mounted display device 102. Therefore, it may cause a collision in use and may also make the imaging unclear.

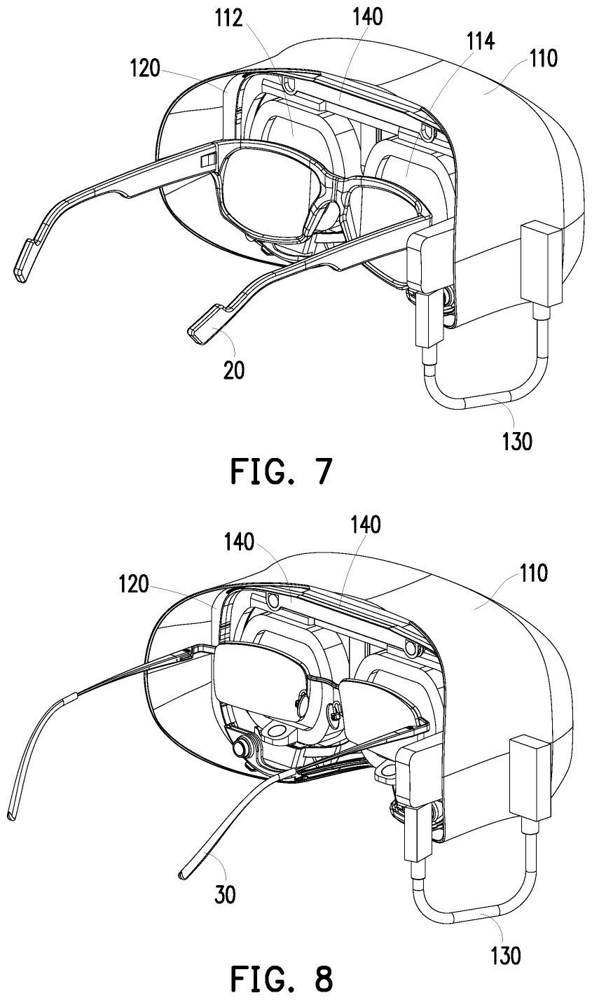

FIG. 7 is a schematic diagram of the relative positions of the head-mounted display device of FIG. 6 and a pair of glasses of a user. Referring to FIG. 6 and FIG. 7, since the head mounted display device 102 of the embodiment includes the distance extender 140, for example, when the user wears the glasses 20, the user can install the distance extender 140 on the eye tracking module 120 to solve the aforementioned problems. In addition, although the conventional head-mounted display device is equipped with a mechanism for adjusting the eye relief distance, it also brings about the problems of complicated design, difficult assembly, and a substantial increase in cost and weight. On the contrary, the design and use of the distance extender 140 of the embodiment are relatively convenient, the structure is simple, and the cost and weight are also low. Although two distance extenders 140 are shown in FIG. 6, the user only installs one distance extender 140 in FIG. 7, and the number of distance extenders 140 can be increased or decreased as required. The face gasket 150 is suitable to be assembled to the distance extender 140, and the distance extender 140 is located between the face gasket 150 and the eye tracking module 120. In order to facilitate the understanding of the eye relief distance, the face gasket 150 is omitted in FIG. 7.

FIG. 8 is a schematic diagram of the relative positions of the head-mounted display device of FIG. 1 and another glasses of a user. Referring to FIG. 6 and FIG. 8, the number of distance extenders 140 in the embodiment is multiple. Regardless of whether different users or the same user wears different glasses 30, the situation that the eye relief distance must be adjusted may be caused. In the head-mounted display device 102 of the embodiment, the number of distance extenders 140 can be increased according to requirements, which can quickly and conveniently achieve the purpose of adjusting the eye relief distance. In the embodiment, the distance extender 140 close to the eye tracking module 120 is magnetically assembled to the eye tracking module 120. The distance extender 140 close to the face gasket 150 is magnetically assembled to the face gasket 150.

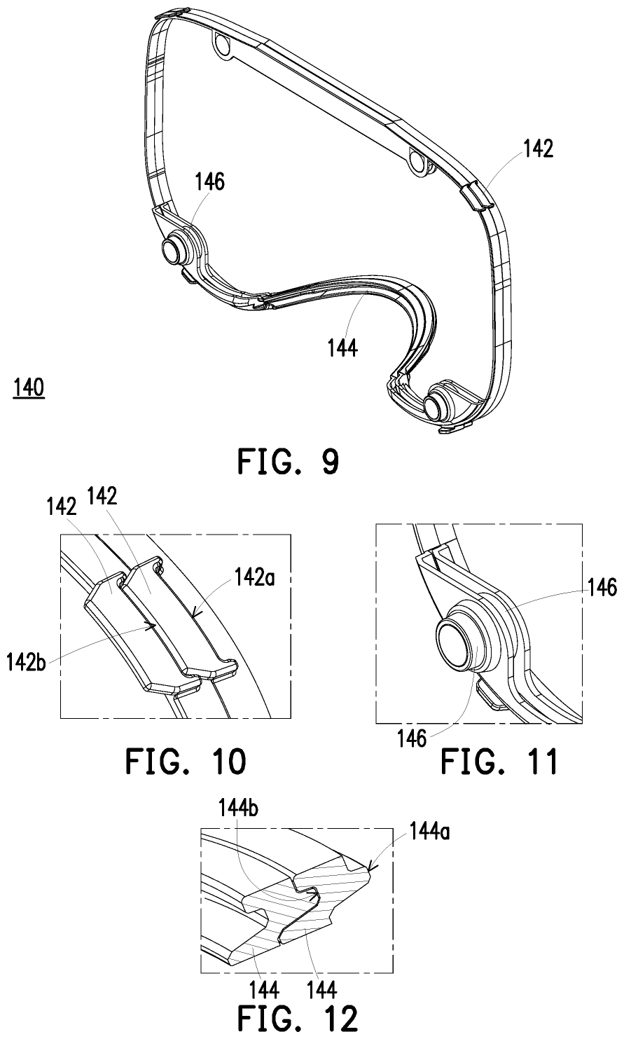

FIG. 9 is a schematic diagram of two distance extenders of the head-mounted display device of FIG. 7. FIG. 10 is a partial enlarged view of the two distance extenders of the head-mounted display device of FIG. 7 at the engaging pieces. Referring to FIG. 9 and FIG. 10, each distance extender 140 in the embodiment has a plurality of engaging pieces 142. The contour 142a of the side facing the eye tracking module 120 (shown in FIG. 8) of each engaging piece 142 matches the contour 142b of the other side facing away from the eye tracking module 120. Therefore, the side facing the eye tracking module 120 of the engaging pieces 142 of the distance extender 140 on the right side in FIG. 10 can be engaged with the side facing away from the eye tracking module 120 of the engaging pieces 142 of the distance extender 140 on the left side. For example, each assembly of distance extender 140 can increase the distance between the eye and the lens by 3 mm, and the wedge angle of the side of the engaging pieces 142 can be 9.5˜20 degrees.

FIG. 11 is a partial enlarged view of the two distance extenders of the head-mounted display device of FIG. 7 at the magnetic attraction portion. Referring to FIG. 9 and FIG. 11, each of the distance extenders 140 has a magnetic attraction portion 146 for magnetically attracting the magnetic attraction portion 146 of the other distance extender 140. Therefore, in FIG. 11, the magnetic attraction portion 146 of the right distance extender 140 can magnetically attract the magnetic attraction portion 146 of the left distance extender 140.

FIG. 12 is an enlarged partial cross-sectional view of the two distance extenders of the head-mounted display device of FIG. 7 at the nose frame portion. Referring to FIG. 9 and FIG. 12, each of the distance extenders 140 of the embodiment has a nose frame portion 144. The contour 144a of one side of each nose frame portion 144 facing the eye tracking module 120 is consistent with the contour 144b of the other side facing away from the eye tracking module 120. Therefore, in FIG. 12, the side of the nose frame portion 144 of the right distance extender 140 facing the eye tracking module 120 can be engaged with the side of the nose frame portion 144 of the left distance extender 140 facing away from the eye tracking module 120.

In this way, even if a plurality of distance extenders 140 are to be assembled, it can be easily and accurately completed.

To sum up, in the head-mounted display device of the application, the lens frame and the camera of the eye tracking module are assembled on the outer frame. As long as the positioning of the outer frame and the body is completed, it is equivalent to completing the positioning between the cameras of the eye tracking module and the lens of the body, which can ensure the normal functioning of the eye tracking function. In addition, when a distance extender is provided, the eye relief distance can also be adjusted in a low-cost, light-weight, and easy-to-implement manner.

What is claimed is:

1. A head-mounted display device, comprising:
a body, has a first lens and a second lens corresponding to both eyes, and also has a first positioning portion;
an eye tracking module, assembled to and electrically connected to the body and comprises an outer frame, a first camera, a second camera, a first lens frame and a second lens frame, wherein the outer frame has a second positioning portion, the second positioning portion is used for connecting with the first positioning portion, so that the outer frame is positioned on the body, the first lens frame and the second lens frame are movably arranged on the outer frame, the first lens frame is used for connecting the first lens, the second lens frame is used for connecting the second lens, the first camera is arranged on the first lens frame, the second camera is arranged on the second lens frame, and the first camera and the second camera are used to shoot both eyes; and
a face gasket, assembled to the eye tracking module, wherein the eye tracking module is located between the face gasket and the body.

2. The head-mounted display device according to claim 1, wherein the number of the first positioning portion and the second positioning portion is multiple, the second positioning portions are magnetically assembled to the first positioning portions, and the second positioning portions are respectively located on opposite sides of the first lens frame and the second lens frame.

3. The head-mounted display device according to claim 1, further comprises a cable, electrically connected to the body and the eye tracking module.

4. The head-mounted display device according to claim 1, further comprises a distance extender, disposed on the side of the eye tracking module facing the user, wherein the face gasket is suitable for assembling to the distance extender, and the distance extender is located between the face gasket and the eye tracking module.

5. The head-mounted display device according to claim 4, wherein the number of the distance extender is multiple.

6. The head-mounted display device according to claim 5, wherein each of the distance extenders has a plurality of engaging pieces, and the contour of one side of each of the engaging pieces facing the eye tracking module is consistent with the contour of the other side facing away from the eye tracking module.

7. The head-mounted display device according to claim 5, wherein each of the distance extenders has a nose frame portion, and the contour of one side of each nose frame portion facing the eye tracking module is consistent with the contour of the other side facing away from the eye tracking module.

8. The head-mounted display device according to claim 5, wherein each of the distance extenders has a magnetic attraction portion for magnetically attracting the magnetic attraction portion of the other distance extenders, the distance extender near the eye tracking module is magnetically assembled to the eye tracking module, and the distance extender near the face gasket is magnetically assembled to the face gasket.

9. An eye tracking module applied to a head-mounted display device, wherein the eye-tracking module is assembled and electrically connected to a body of the head-mounted display device, and the eye tracking module is located between a face gasket of the head-mounted display device and the body,
the eye tracking module comprises an outer frame, a first camera, a second camera, a first lens frame and a second lens frame, wherein the outer frame has a second positioning portion, the second positioning portion is used for connecting with a first positioning portion of the body, so that the outer frame is positioned on the body, the first lens frame and the second lens frame are movably arranged on the outer frame, the first lens frame is used for connecting a first lens of the body, the second lens frame is used for connecting a second lens of the body, the first camera is arranged on the first lens frame, the second camera is arranged on the second lens frame, and the first camera and the second camera are used to shoot both eyes.

10. The eye tracking module according to claim 9, wherein the first positioning portion is a positioning post.

11. The eye tracking module according to claim 10, wherein the second positioning portion magnetically attracts the first positioning portion.
